(19) United States
(12) Patent Application Publication
(10) Pub. No.: US 2022/0192806 A1
(43) Pub. Date: Jun. 23, 2022

(54) EXTRA ORAL DENTAL VENTILATOR

(71) Applicant: Mark G. PALUMBO, Atlantic Beach, NY (US)

(72) Inventor: Mark G. PALUMBO, Atlantic Beach, NY (US)

(21) Appl. No.: 17/561,593

(22) Filed: Dec. 23, 2021

Related U.S. Application Data
(63) Continuation-in-part of application No. 17/009,411, filed on Sep. 1, 2020.
(60) Provisional application No. 63/022,378, filed on May 8, 2020.

(51) Int. Cl. A61C 17/08

(52) U.S. Cl. CPC A61C 17/08

(57) ABSTRACT

There is disclosed a dental device configured to be coupled to a vacuum. In at least one embodiment the device comprises at least one channel coupled to the vacuum and in fluid communication with the vacuum. In addition, there can be at least one hood coupled to the channel, and covering the channel wherein the hood is in fluid communication with said at least one channel. In addition, there can be at least one clip coupled to the hood. Furthermore, said at least one clip extending substantially perpendicularly to said at least one hood and substantially parallel to said at least one channel, wherein the vacuum is configured to create a negative pressure inside of said at least one hood, and wherein said at least one clip is configured to couple to a user's mouth, wherein said hood is positioned adjacent to a user's mouth.

### CROSS REFERENCE TO RELATED APPLICATIONS

This application is a continuation in part application of International Application Serial No. PCT/US2021/031411 filed on May 7, 2021. The international Application is a Continuation in Part Application of U.S. patent Ser. No. 17/009,411 filed on Sep. 1, 2020, which is a non-provisional application which claims priority from U.S. provisional application Ser. No. 63/022,378 filed on May 8, 2020, the disclosure of all of these applications are hereby incorporated by reference in their entirety.

### BACKGROUND

The invention relates to a dental aeration and aspiration device. The dental aeration and aspiration device is configured to be placed adjacent to the user's mouth and then configured to be placed adjacent to the user when the user has an open mouth during aerosol and non-aerosol producing events such as a dental prophylaxis or dental restorative procedures.

With the ever present and increasing awareness of respiratory transmitted diseases, there is a need for the removal of potential pathogens utilizing a device that is inexpensive, non-obtrusive and safe for medical and/or dental practitioners. A dental healthcare provider who may need to be within two feet of a patient for an extended period of time would desire to have the treated patients' expirations, fluids within the oral cavity, and/or procedure producing aerosols cleared from the operating field, thereby reducing the exposure to harmful pathogens. Thus, there is a need for an aeration/aspiration device that will simultaneously draw the expirations, fluids from the oral cavity, and aerosols of the treatment field away from the medical or dental practitioner in a safe, secure and efficient manner.

### SUMMARY

At least one embodiment of the invention relates to a dental device configured to be coupled to a vacuum. In at least one embodiment the device comprises at least one channel coupled to the vacuum and in fluid communication with the vacuum. In addition, there can be at least one hood coupled to the channel and covering the channel wherein the hood is in fluid communication with said at least one channel.

In addition, there can be at least one clip coupled to the hood. Furthermore, said at least one clip extending substantially perpendicularly to said at least one hood and substantially parallel to said at least one channel, wherein the vacuum is configured to create a negative pressure inside of said at least one hood, and wherein said at least one clip is configured to couple to a user's mouth, wherein said hood is positioned adjacent to a user's mouth.

In at least one embodiment the dental device can comprise at least one additional channel in communication with the first channel.

In at least one embodiment the additional channel is smaller in diameter than the first channel.

In at least one embodiment at least one additional channel extends at least partially inside of the clip.

In at least one embodiment the clip comprises at least two parts comprising a first part and a second part, wherein the second part is disposed at least partially inside of the part of said clip and wherein the second part is slidable inside of said first part thereby forming a telescoping clip that is adjustable in length. In at least one embodiment, the clip can rotate in a substantially 360 degree rotational manner so that the clip can be orientated at any angle vs. the hood.

In at least one embodiment, the hood is semi spherical. Furthermore, in at least one embodiment, the hood is formed substantially clam shell in shape.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a front-bottom perspective view of a first embodiment of a dental device;

FIG. 2 is a front-top perspective view of the first embodiment of the dental device;

FIG. 3 is a side cross-sectional view of the first embodiment of the dental device;

FIG. 3A is a view of extensible section;

FIG. 3B is a view of an outer frame for receiving the extensible section;

FIG. 3C is a cross-sectional view of the extensible section;

FIG. 3D is a cross-sectional view of the outer frame;

FIG. 3E is a top cross-sectional view of the outer frame taken along line I-I;

FIG. 3F is a perspective cut out view of the outer frame;

FIG. 4 is a front-bottom perspective view of a second embodiment of a dental device;

FIG. 5 is a front-top perspective view of the second embodiment of the dental device;

FIG. 6 is a side cross-sectional view of the second embodiment of the dental device;

FIG. 7 is a front-bottom perspective view of a third embodiment of a dental device;

FIG. 8 is a front-top perspective view of the third embodiment of the dental device;

FIG. 9 is a side cross-sectional view of the third embodiment of the dental device;

FIG. 10 is a view of the entire component system;

FIG. 11A is a side view of another embodiment;

FIG. 11B is a front view of the embodiment of FIG. 11A;

FIG. 11C is a perspective view of the embodiment of FIG. 11A;

FIG. 11D is a top view of the embodiment of FIG. 11A;

FIG. 12A is a side cross-sectional view of the embodiment of FIG. 11A taken along line i-i shown in FIG. 11B;

FIG. 12B is a top view of the cross-sectional view of FIG. 12A;

FIG. 12C is a front view of the section of FIG. 12A;

FIG. 13A is a top view of the connections for the flange of FIG. 11A;

FIG. 13B is a top view of the connections for the flange of FIG. 14A;

FIG. 13C shows a top view of the clip which is rotated 180 degrees vs. the outer frame;

FIG. 14A is a front exploded perspective view of another embodiment showing a body of the device and the flange with multiple connections;

FIG. 14B is a front perspective connected view of the embodiment of FIG. 14A;

FIG. 14C is a front-side perspective view of the embodiment of FIG. 14A;

FIG. 15A is a side view of the outer frames;

FIG. 15B is a side view of the clips inserted into the hood in a locked position;

FIG. 15C is a side view of the hood showing the different angled faces of the hood; and

FIG. 15D is a side view of the hood having the clips rotated up during the insertion of the clips into the hood;

FIG. 16A is a side cross-sectional view of another embodiment of the device;

FIG. 16B is another side cross-sectional view with the arms moved in a different location;

FIG. 16C is a front view of the embodiment of FIG. 15A with the arm in a first position;

FIG. 16D is a front view of the embodiment of FIG. 15A with the arm in a second position;

FIG. 17A shows a perspective view of the hood section coupling to the upper arm;

FIG. 17B shows a side cut away view of the device of FIG. 16A;

FIG. 18 is a front view of the hood section;

FIG. 19A shows an exploded view of the hood section;

FIG. 19B shows a cut away view of the hood section;

FIG. 19C shows a top cut-away view of the device coupled together;

FIG. 20A is a side view of the upper arm;

FIG. 20B is a front view of the upper arm;

FIG. 20C is a side cross-sectional view of the upper arm;

FIG. 21A is a side transparent view of the lower arm;

FIG. 21B is a front upside down view of the lower arm;

FIG. 21C is a perspective view of the lower arm;

FIG. 21D is a back view of the lower arm;

FIG. 21E is a side view of the lower arm;

FIG. 22 is a side cut away perspective view of the device without the hood;

FIG. 23A is a front perspective view of the shortened version of the device;

FIG. 23B is a side view of the shortened version of the device;

FIG. 23C is a top perspective view of the shortened version of the device; and

FIG. 23D is a view of a valve for use with the device.

### DETAILED DESCRIPTION

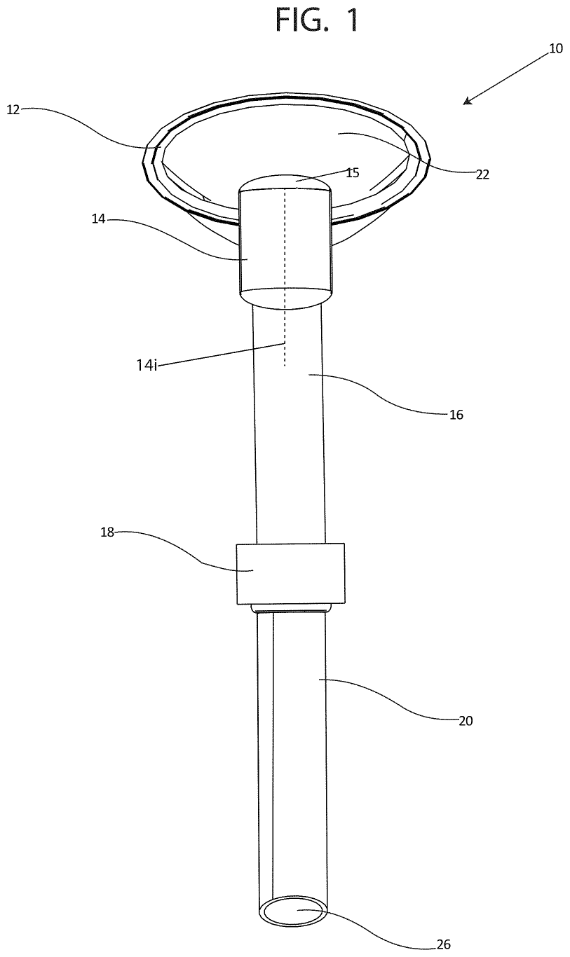

FIG. 1 is a front-bottom perspective view of a first embodiment of a dental device 10 which comprises a hood 12, a first shaft 16 and a second shaft 20 wherein the first shaft 16 has a first channel and the second shaft also has a channel or at least one additional channel or contiguous channel.

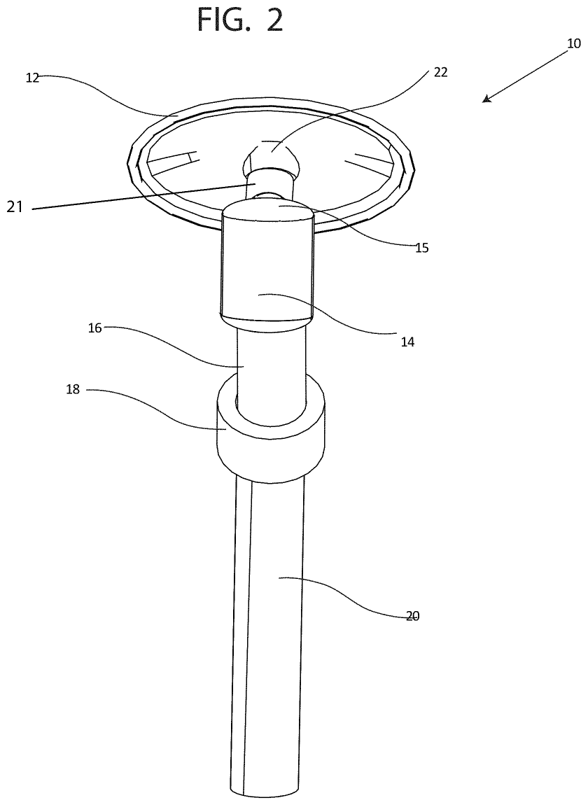

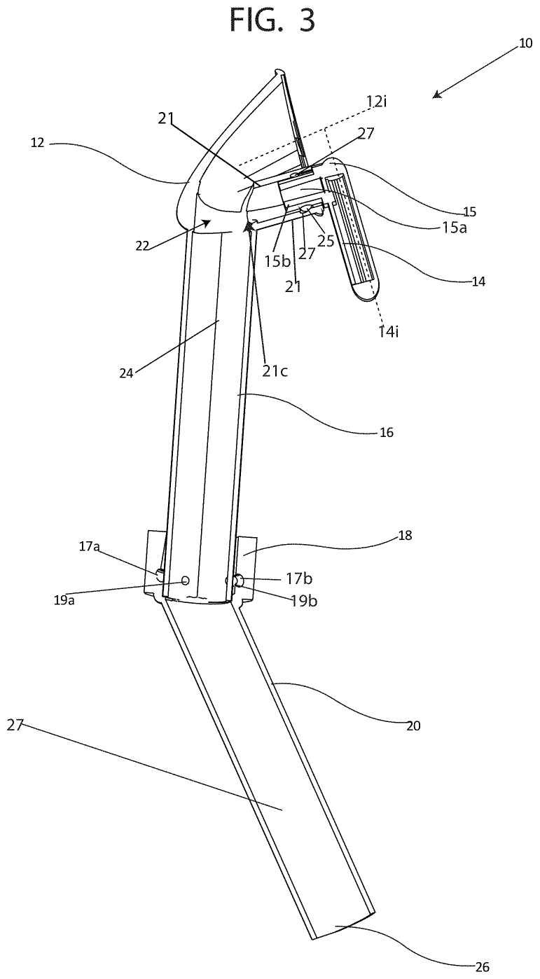

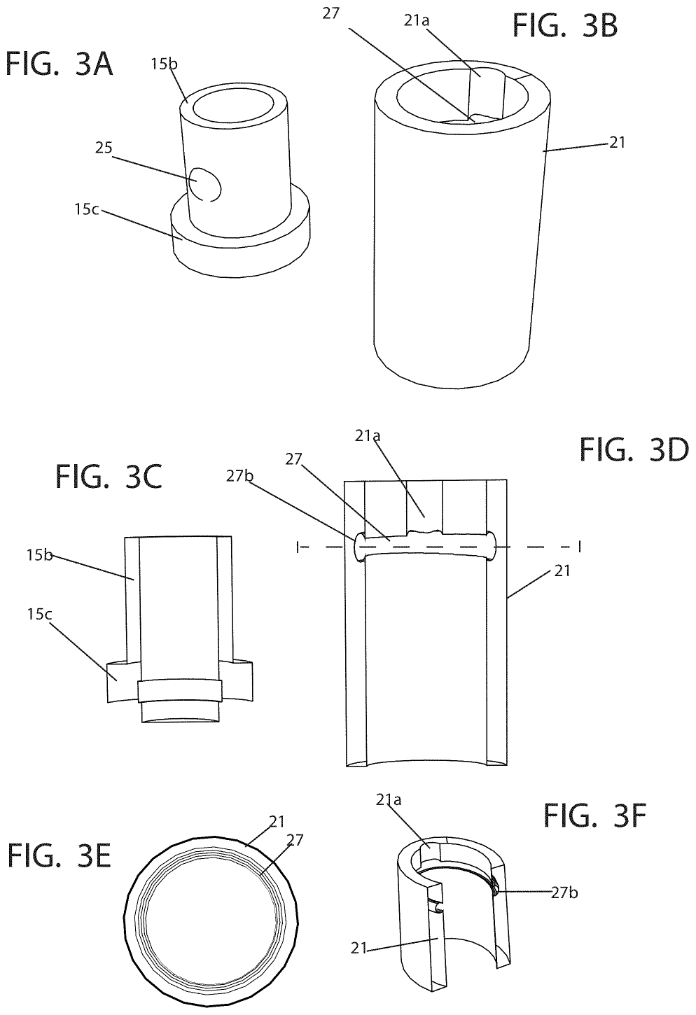

There is at least one clip 14 which extends substantially perpendicular to an extension of the hood 12. For example, clip 14 has a longitudinal extension 14i which extends substantially transverse to the extension of longitudinal extension 12i of hood 12 (see FIG. 3). There is a cross flange 15 which extends out to clip 14. In addition, extending down from hood 12 is a first shaft 16 which extends down to a rotatable connector 18. Rotatable connector 18 is coupled at a first end to first shaft 16 and at a second end to second shaft 20. Disposed inside of rotatable connector 18 are protrusions 19 and indents 17 (See FIG. 3). Hood 12 includes a hood opening 22 (See FIG. 2) which extends down into a channel which runs through first shaft 16, connector 18, and second shaft 20. A vacuum pump can be connected at the end of shaft 20 so that it creates a vacuum of negative pressure inside of hood 12, hood opening 22, and inside of shaft 16, connector 18, and shaft 20. The hood 12, the shafts 16 and 20 and the clip can be molded, 3D printed, extruded or manufactured in any known way from any suitable material such as plastic, biodegradable materials, such as paper or composites, metal or any other suitable material. In at least one embodiment, the entire device, both body (hood 12 and shafts 16, connector 18 and clip 14, is a plastic intended for single use and disposable. In at least one other embodiment, the body (hood 12 and shafts 16 and 20 and connector 18) is made of a material which is reusable and sterilizable, with the clips 14 being made of a plastic intended for single use and disposable.

FIG. 2 is a front-top perspective view of the first embodiment of the dental device. Among the different components, there is shown hood 12, hood opening 22, and slots or an outer frame 21 inside of hood 12. Cross flange 15 and clip 14 are also shown along with shafts 16 and 20 and rotatable connector 18.

FIG. 3 is a side cross-sectional view of the first embodiment of the dental device. In this view there is shown hood 12, and longitudinal extension of hood 12i. There is shown cross flange 15, as well as clip 14. Longitudinal line 12i extends along the longitudinal extension of hood 12 and parallel to flange 15. This longitudinal line 12i extends substantially transverse to longitudinal line 14i which extends along clip 14. As shown in this side cross-sectional view, there is shown hood opening 22 which extends down to shaft 16 having opening or channel 24 which forms a channel which extends down to connector 18. This channel 24 is inherent in the cylindrical design of shaft 16, thereby allowing fluid flow such as air to follow through hood 12, through opening 22, into channel 24 in shaft 16 and down into connector 18.

Connector 18 is coupled to and in at least one embodiment directly connected to second shaft 20. First shaft 16 is positioned inside of connector 18 and which has protrusions 19a, and 19b which insert into corresponding indents 17a and 17b. Indents 17a and 17b are part of a continuous annular slot disposed within 18 for 19a and 19b to engage with a protrusion. This allows the shaft 16 to be rotatable vs. connector 18 and shaft 20 or alternatively allows collar and shaft 20 to be rotatable vs. first shaft 16. Inside of second shaft 20 is an opening 27 which allows air to flow therethrough and into a vacuum pump. At an end of shaft 20 is an end piece 26.

In addition, clip 14 is coupled to hood 12 via a flange 15 as well as an extensible section 15b. Extensible section 15b has a hollow region 15a. Because of hollow region 15a, extensible section 15b is collapsible inside of an outer frame 21 of hood 12. Coupled to extensible section 15b is protrusion 25 which is configured to insert into indent 27 which is formed as a ring disposed inside of outer frame 21. This allows clip 14 to be inserted into outer frame 21 on hood 12.

As shown in FIGS. 3A-3F, indent 27 is an indent running 360 degrees around the inner aspect of outer frame 21, there is also an indent (27a) starting at and running perpendicular to indent 27, continuous to the outer edge of the outer frame 21. Thus, each of the clips as shown in FIGS. 1-9 can be rotated in an “up” position, protrusion 25 aligns with indent 27a and can be inserted until protrusion 25 meets with indent 27. Once rotated down (into it's functional position), the clip becomes “locked” and engaged. All variations of clips are interchangeable and can be placed, removed, and exchanged as needed.

For example, FIG. 3A is a perspective view of the extensible section 15b which has a protrusion 25, as well as an intermediate base 15c. FIG. 3B is an outer frame 21 having a first slot or indent 21a. There is also another indent or slot 27 which is an annual slot running in a ring inside of outer frame 21.

FIG. 3C shows a cross-sectional view of the extensible section 15b having an intermediate base 15c and base 15d. FIG. 3D is a cross-sectional view of the outer frame having indent or slot 21a as well as annular ring, slot or indent 27 extending around the inner portion of outer frame 21. This slot, ring or indent 27 has a curvature 27b which shows that this slot is rounded so that it is configured to receive protrusion 25 as it engages this slot or ring 27 allowing an associated clip 14, 114, or 214 to be rotated into a desired position.

Additional views of this slot, ring or indent 27 are also shown in FIGS. 3E and 3F which show ring or indent 27, having curvature 27b in outer frame 21 which also has indent or slot 21a as well. The adjustability of the clip 14, 114, and 214, allows for the device to be adjusted in position in a user's mouth so that a more comfortable angle of clip 14, 114, and 214 can be achieved and also so that it can be better positioned to draw fluids from a patient's mouth.

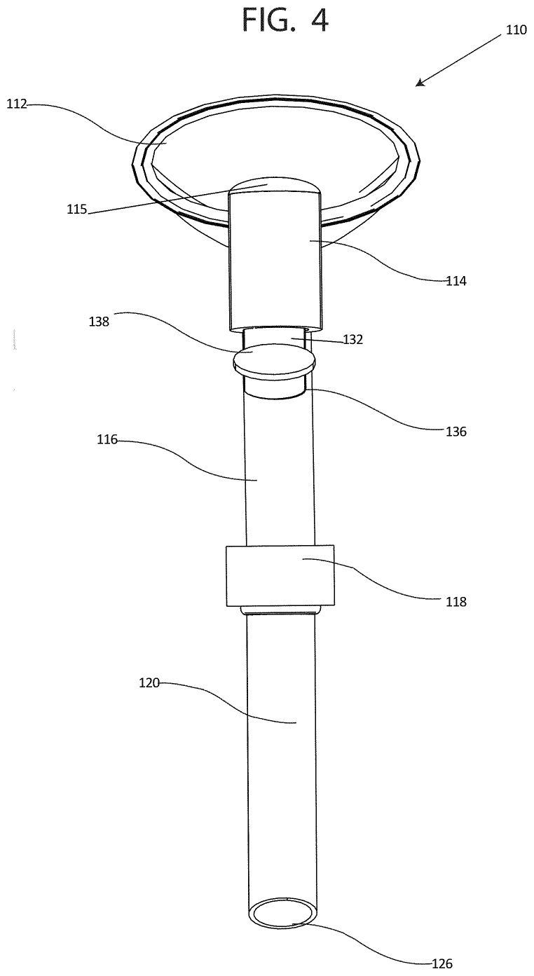

FIG. 4 is a front-bottom perspective view of a second embodiment of a dental device 110. The dental device 110 includes a hood 112, and a flange 115 extending out from hood 112. Coupled to flange 115 is a clip 114. In addition, disposed inside of clip 114 is an inner shaft 132 which is telescoping inside of clip 114 so that clip 114 is variable in length. In addition, coupled to shaft 132 is an end flange 138 which extends transverse to the inner shaft 132. First shaft 116 extends down to rotatable connector 118 and is rotatably coupled thereto. In addition, rotatable connector 118 is coupled to or connected with second shaft 120. At the bottom of second shaft 120 is an opening 126. Essentially shaft 116 snaps into rotatable connector 118 for this rotatable connection.

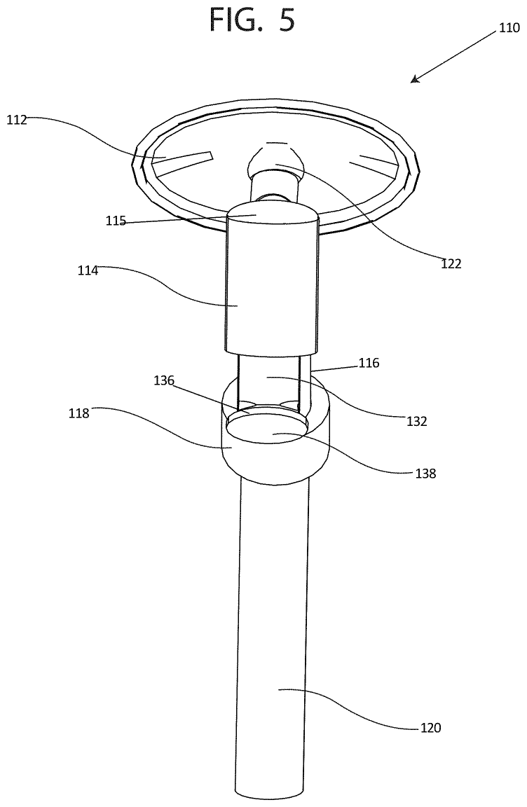

FIG. 5 is a front-top perspective view of the second embodiment of the dental device 110 which shows hood 112, hood opening 122. Extending out from hood 112 is a cross flange 115 which extends substantially perpendicular to clip 114. Adjacent to clip 114 is a shaft 116. In addition, disposed inside of clip 114 is inner shaft 132. Coupled to inner shaft 132 is a transverse shaft 136. In addition, coupled to transverse shaft 136 is an end flange 138.

Furthermore, coupled to shaft 116 is rotatable connector 118. Coupled to rotatable connector 118 is a second shaft 120. Second shaft 120 extends down to a connection with a vacuum to create negative pressure inside of hood 112.

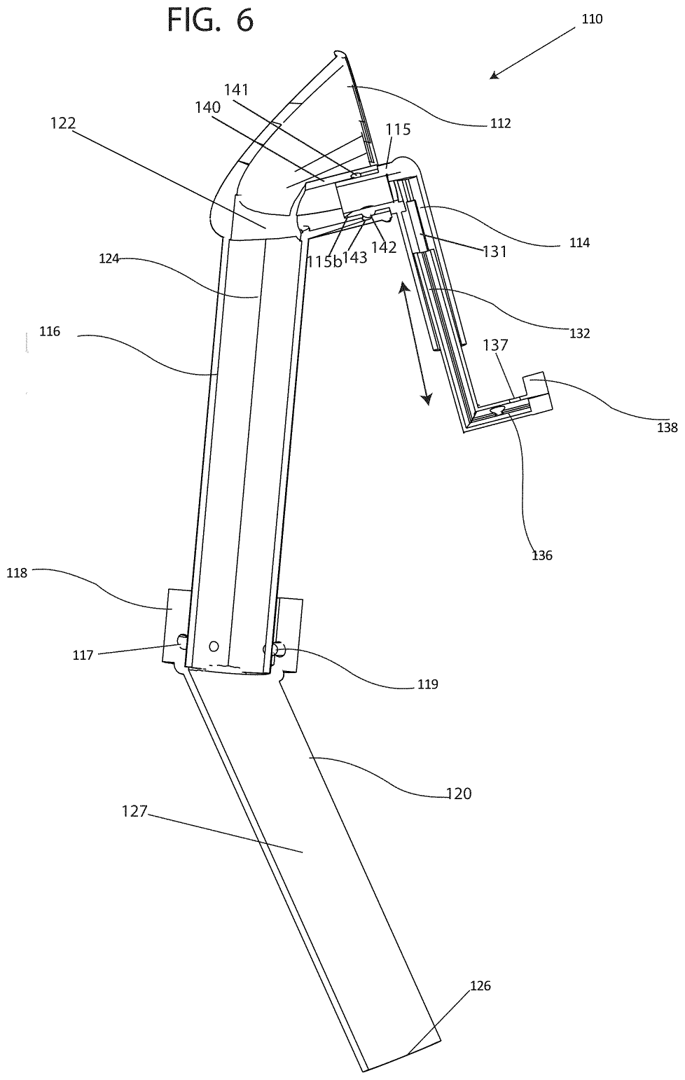

FIG. 6 is a side cross-sectional view of the second embodiment of the dental device 110. This dental device includes a hood 112 which has a hood opening 122. Hood opening extends into shaft 116. Inside shaft 116 is opening 124 which extends down to opening 127 which is inside of shaft 120. As stated above, shaft 120 is coupled to rotatable coupling 118. Shaft 116 has protrusions 119 while rotatable coupling 118 has indents 117. Thus, the protrusions 119 fit inside of the indents 117. Shaft 120 extends down from coupling or rotatable connector 118 to opening 126 which is configured to be coupled to a vacuum which draws air and creates a negative pressure inside of hood 112 thereby drawing air out of a user's mouth. In addition, this side view shows clip 114 which includes an inner shaft 132 slidable inside of clip 114 along track 131 thereby showing clip 114 is adjustable in length. In addition, shaft 132 extends to transverse shaft 136, which then extends out towards end flange 138. In addition, clip 114 extends along flange 115 inside of channel 140 to connect clip 114 to the body of the device. Channel 140 has indents 141 and 143 configured to receive protrusions 142 allowing the clip 114 to snap therein while still being rotatably adjustable.

Ultimately this embodiment is configured to allow for adjustment of the clip in a substantially vertical manner to allow a further extension of the clip 114 into the user's mouth. The second embodiment is also dual purpose which is capable of aeration or ventilation, as well as aspiration (drawing of fluid out of the user's mouth). Thus, transverse shaft 136 has an opening 137 for receiving fluid such as saliva or aspiration or exhalation therein. This fluid would then travel up shaft 136, through shaft 132 through shaft 115b into opening 122 down through opening 124 in shaft 116, through connector 118 through opening 127 in shaft 120 and down into a vacuum. In addition, flange 138 and the underside of 136 function by design in inhibiting the soft tissue of the oral cavity from obstructing opening 137

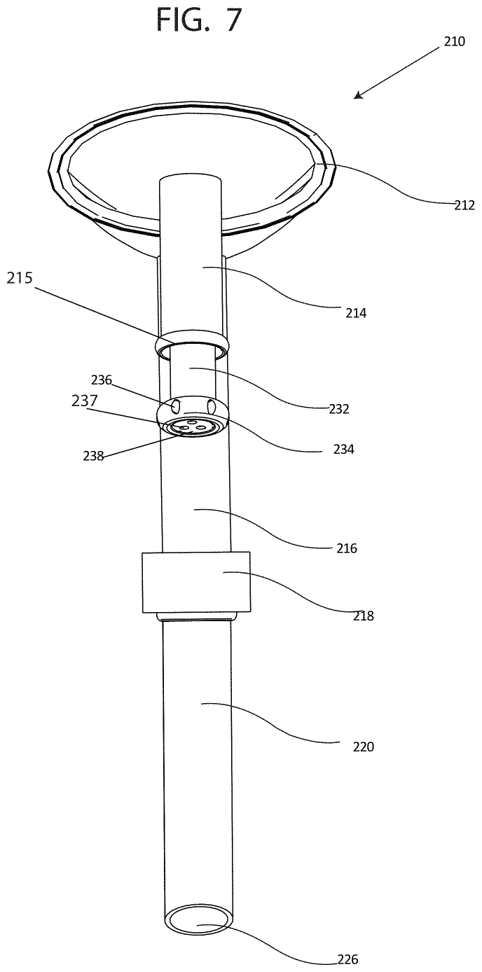

FIG. 7 is a front-bottom perspective view of a third embodiment of a dental device 210. This embodiment includes a hood 212, a flange 214 as well as an inner shaft 232. This embodiment is configured so that it is capable of both aeration and aspiration so that it serves a dual purpose.

Thus, in addition, coupled to inner shaft 232 is flange 234 which has holes 236 which is configured to receive fluid from a person's mouth when shaft 232 is inserted into the user's mouth. In addition, there is also an additional interface 238 comprising a plurality of holes 237 which are configured to draw fluid through these holes into shaft 232. In addition, also disclosed in this view are shaft 216 coupled to coupling or rotatable connector 218. Coupling or rotatable connector 218 is also coupled to second shaft 220. At the bottom of second shaft 220 is opening 226 which is configured to be coupled to a vacuum device configured to create a vacuum inside of hood 212.

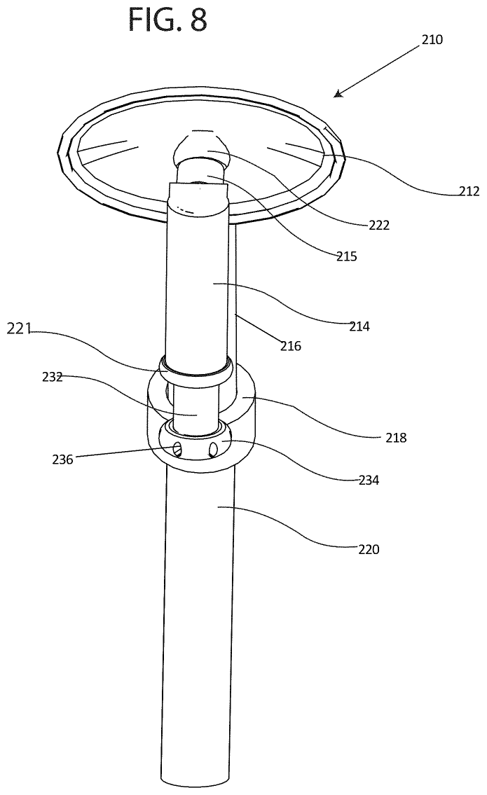

FIG. 8 is a front-top perspective view of the third embodiment of the dental device 210, which discloses a hood 212 having an opening 222. Extending out from hood in a manner substantially coaxial with the longitudinal extension of hood 212 is cross flange 215 which extends in a transverse manner to clip 214. Clip 214 extends substantially coaxial with shaft 216 down to rotatable connector 218. Coupled to rotatable connector 218 is second shaft 220. In addition, as shown, coupled to clip is inner shaft 232 which extends down to flange 234. Disposed in flange 234 are openings or holes 236. Furthermore, there is also shown second shaft 220 which extends down from connector 218.

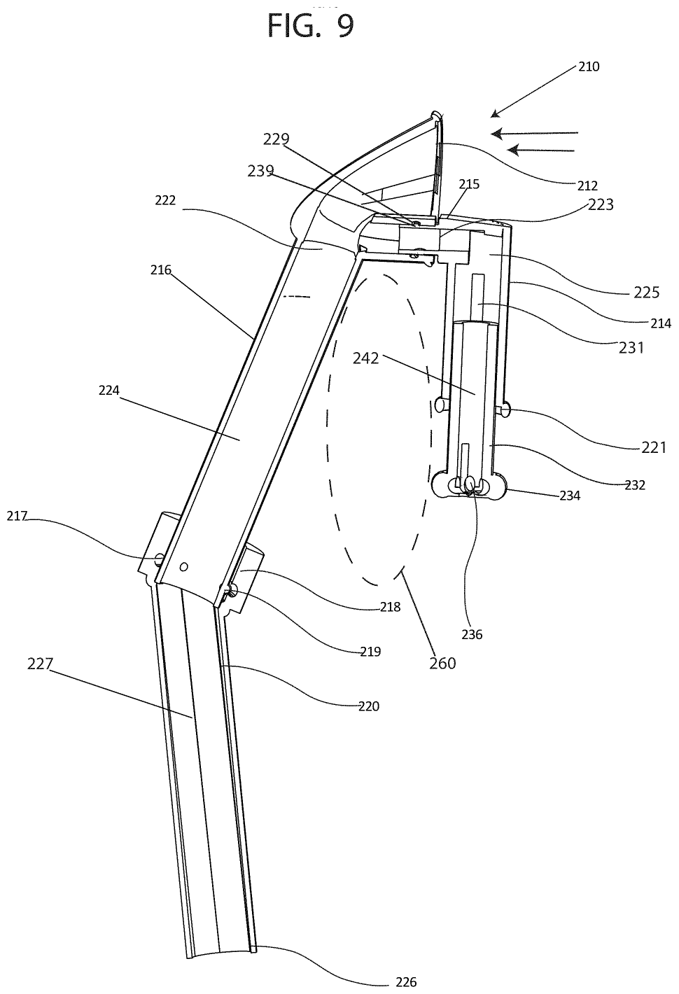

FIG. 9 is a side cross-sectional view of the third embodiment of the dental device 210 which shows a hood 212 which is configured to receive air expelled from a user as shown by arrows positioned adjacent to the reference numeral 212 of hood 212. This view also shows a side profile of a users' cheek 260 which is configured to receive the clip 214. Clip 214 can be in the form of a flange or a shaft which is configured to extend inside of a user's mouth. Thus, this clip 214 extends down into the user's mouth and is configured to draw air, saliva and other fluids out of the user's mouth. At a first end of clip 214 is a cross flange 215, which has inside of it a channel 223. Channel 223 has at least one outside protrusion 239 which fits inside of a corresponding indent 229 in shaft

Inside of clip or shaft is an inner shaft 232 which is slidable along a track 231. Track 231 is coupled to clip 214 and thereby allows inner shaft 232 to slide therein. At the bottom of clip 214 is a ring protrusion 221. In addition, inner shaft 232 has a ring 234 as well. As described above ring 234 has holes 236 disposed therein. Holes 236 and holes 237 (See FIG. 7) are configured to draw saliva, expired respiration and other fluids out of the users' mouth. At the same time hood 212 which has therein a negative pressure or vacuum is configured to draw expired air from the use and into this vacuum. Thus, air is drawn into hood 212 into opening 222, into channel or opening 224, through shaft 216, into channel or opening 227 in shaft 220 and then through opening 226 which is ultimately connected to a vacuum hose. In addition, fluid such as saliva, water or other expired gasses are pulled through holes 236 and 237 into channel 242, into channel 225, through channel 223, into opening 222, through channel or opening 224, through channel or opening 227 and into a corresponding vacuum hose and eventually a vacuum. Thus, this vacuum is creating a consistent state of negative pressure in the different channels in the device to draw the expired gasses from a user as well as other fluids from the user.

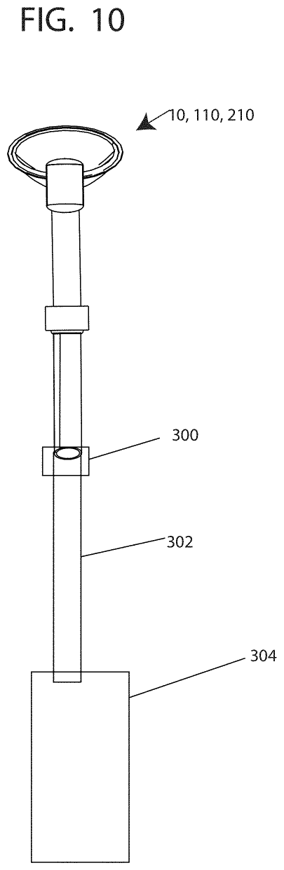

FIG. 10 shows a diagram of a device such as the first embodiment of dental device 10, the second embodiment of a dental device 110 or the third embodiment of the dental device 210 which can be coupled to a coupling 300. Coupling 300 is coupled to a vacuum hose 302 which feeds into a standard dental vacuum 304. This standard dental vacuum is the type of vacuum which is housed in a standard dental office which is currently used to draw fluids from a patient in a dental chair. The coupling 300 is configured as either a clamp coupling or a female coupling configured to receive an end of the shaft such as any one of shaft 20, 120 or 220. Thus, this device is configured to be coupled to a standard HVE (high volume evacuator) fitting attached to a vacuum system that is currently installed in an existing dental office.

As shown in FIGS. 3, 6 and 9 each of the devices comprise separate components that can be releasably snapped together using protrusions and corresponding indents to selectively allow either a coupling or rotatable connector 18, 118, or 218 to be coupled to an associated shaft 16, 116 or 216. Alternatively, an additional set of protrusions and indents form an interface between the clip such as any one of clip 14, 114, and 214 and the body of the corresponding device such as with device 10, 110 or 210. Therefore, this design results in a modular device which has interlocking components which are adjustable and can be releasably connected to each other.

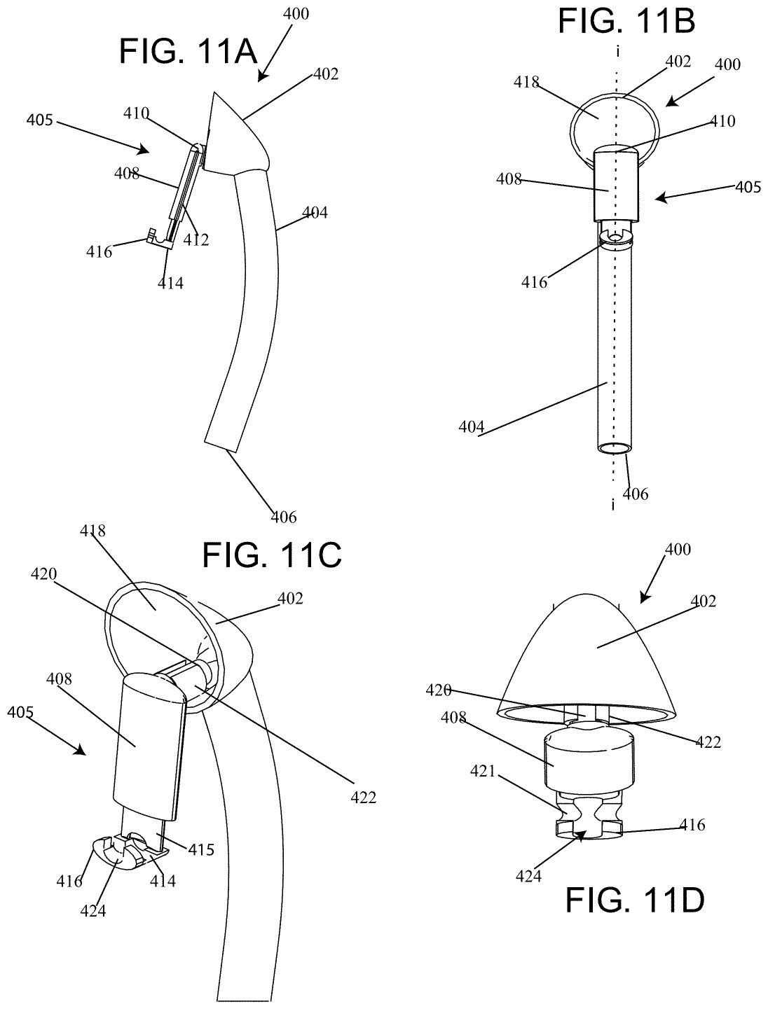

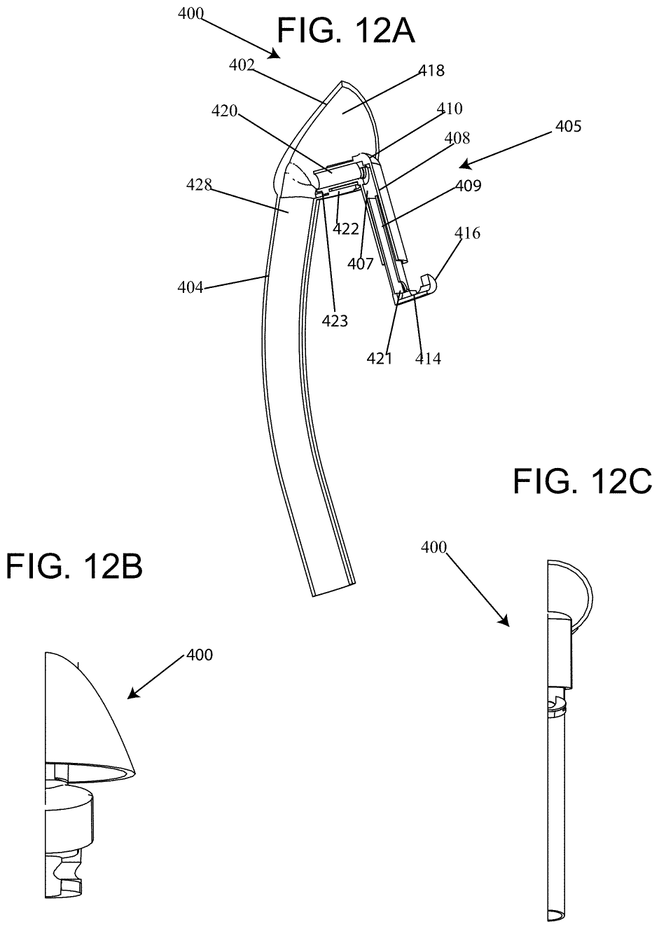

FIGS. 11A, 11B and 11C, and 11D are a side view a front view, a perspective view, and a top view another embodiment 400 which shows a hood 402, coupled to a shaft 404. Shaft 404 has a hollow center and extends down to an end 406. There is a clip 405 which is similar to clips 14, 114, 214, can be used to clip over a user's cheek so that a hood 402 which is similar to hoods 12, 112, and 212 shown above. There is also a shaft 404 which is similar to shafts 16, 116, and 216. Clip 405 includes a clip body 408 which has a slot 412 which is configured to house a shaft 409 (FIG. 12A) which is a telescoping shaft which allows a bottom elbow to slide up and down vs. the outer body 408. End 415 of shaft 409 is shown exposed outside of outer housing 408. Coupled to bottom elbow 414 is a protrusion 416 of clip 405. This protrusion 416 is configured to extend up from elbow 414 so as to inhibit the soft tissue of the oral cavity from obstructing opening 421 as well as keeping opening 424 still open (see FIG. 11D).

Thus, in the bottom elbow 414 of clip 405 there is an opening 424 which allows saliva or air to channel up through an opening in clip 405 (See FIG. 12A which shows a channel inside of inner shaft 409.

FIG. 12A is a side cross-sectional view of the embodiment of FIG. 11A taken along line i-i shown in FIG. 11B. In this view there is shown the embodiment 400 shown in FIG. 11A which includes hood 402 having an opening 418. Hood 402 is coupled to shaft 404. Inside of shaft 404 is a channel 428 which is in fluid communication with opening 418 and allows air and/or saliva to be pulled up therethrough. This channel is in fluid communication with an associated channel inside of attachment shaft 420 as well as down through a channel or open shaft 407 inside of clip body 408 and inside of inner shaft 409 and extending out through opening 421 of clip 405. In addition, clip 405 includes a cross flange or elbow 410 which extends at a substantially perpendicular angle between attachment shaft 420 and clip body 408. FIG. 12B is a top view of the cross-sectional view of embodiment 400 of FIG. 12A. FIG. 12C is a front view of the section of FIG. 12A. Attachment shaft 420 has a lock 423 comprising a protrusion or flange which can be fed inside of outer frame 422 and then turned or twisted so that it forms a lock behind outer frame 422.

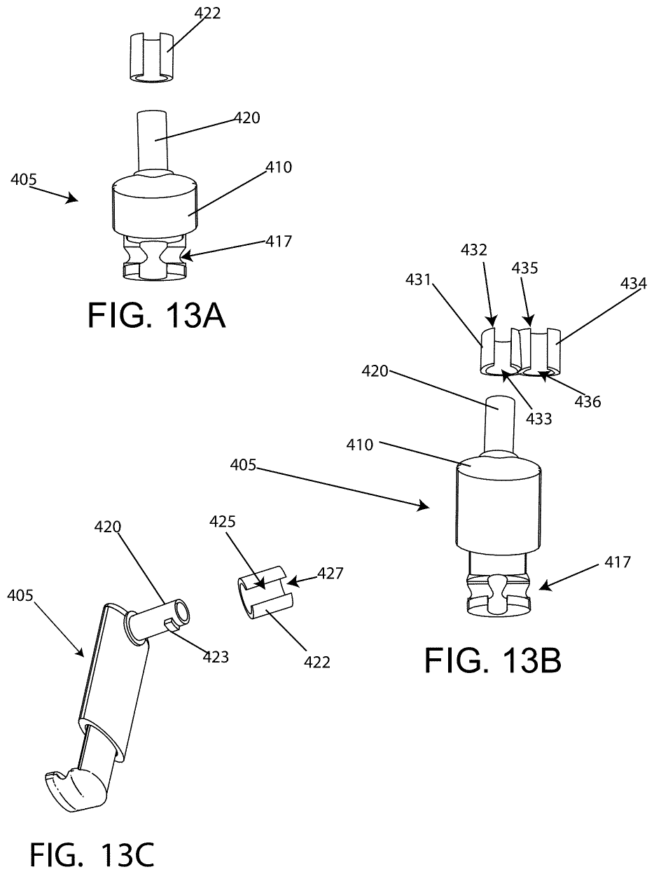

FIG. 13A is a top view of the connections for the flange of FIG. 11A in this view there is shown outer frame 422 which is configured to receive the attachment shaft 420 of clip 405. This view also shows indentation 417 in bottom elbow 414. The attachment shaft 420 is rotatable inside of outer frame 422. Outer frame 422 is configured as substantially cylindrical while attachment shaft is also configured as substantially cylindrical as well.

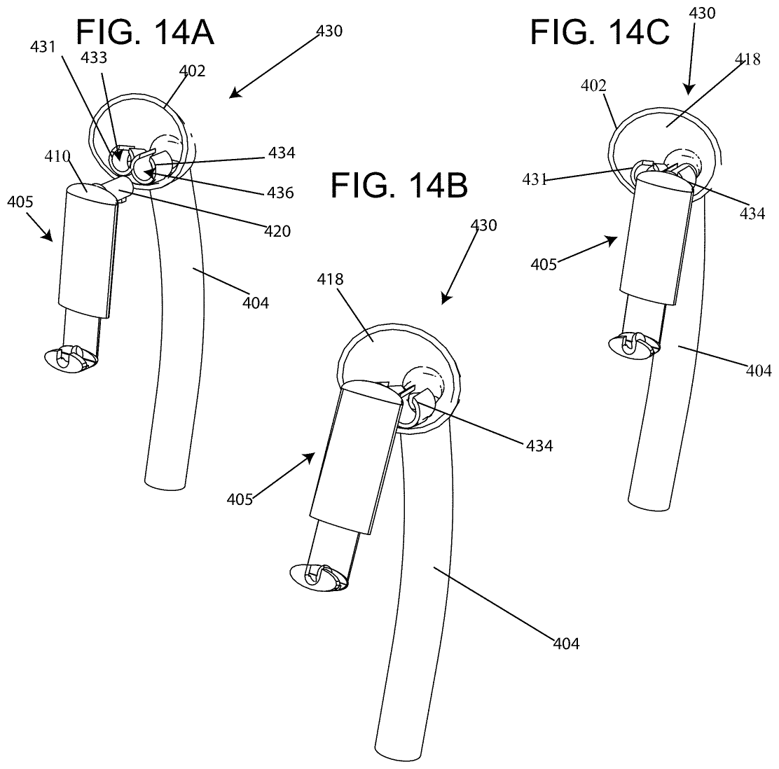

FIG. 13B is a top view of the connections for the flange of FIG. 14A, wherein in this view there are shown other frames 422 and 431 positioned adjacent to each other. Each of outer frames 422 and 431 are formed as broken cylinders which are configured to receive attachment shaft 420 of clip 405. The broken cylinder or incomplete cylinder is configured to expand when receiving attachment shaft 420. This creates a friction fit between shaft 420 and outer frames 422 and 431.

In this view cross flange 410 is shown leading down to bottom elbow 414 (FIG. 11A) which shows indent 417.

FIG. 13C shows a top view of the clip 405 being inserted into the outer frame 422. Outer frame 422 includes an opening 425 which is formed as a slot opening which is configured to receive lock 423. Attachment shaft 420 is configured to slide into opening 427 in outer frame 422 with lock 423 sliding along opening 425. Once lock slides entirely through opening 425, the clip 405 can be rotated thereby rotating lock 423 to lock the lock 423 behind the back end of outer frame 422. This type of slot connection shown in FIG. 13C can also be used for the double connections 422 and 432 shown in FIG.

FIG. 14A is a front exploded perspective view of another embodiment 430 showing hood 402, shaft 404 and clip 405 having cross flange or elbow 410 extending into attachment shaft 420 of clip 405. A plurality of outer frames 431 and 434 are positioned adjacent to each other and having slots or openings 433 and 436 respectively for receiving attachment shaft 420.

FIG. 14B is a front perspective connected view of the embodiment of FIG. 14A which shows clip 405, shaft 404, hood 402 having opening 418 and outer frame 434.

FIG. 14C is a front-side perspective view of the embodiment 430 of FIG. 14A showing hood 402 having an opening, shaft 404, and clip 405. Disposed inside of hood 402 are outer frames, 431 and 434 with attachment shaft 420 (not shown) inserted into outer frame 422.

With the two parallel extending outer frames 431 and 434, this allows for the clip 405 to be adjusted based upon the geometry and shape of a user's mouth so that it is more comfortable for the patient. Outer frames 431 and 434 can be formed as separate pieces or formed as a single piece coupled to hood 402.

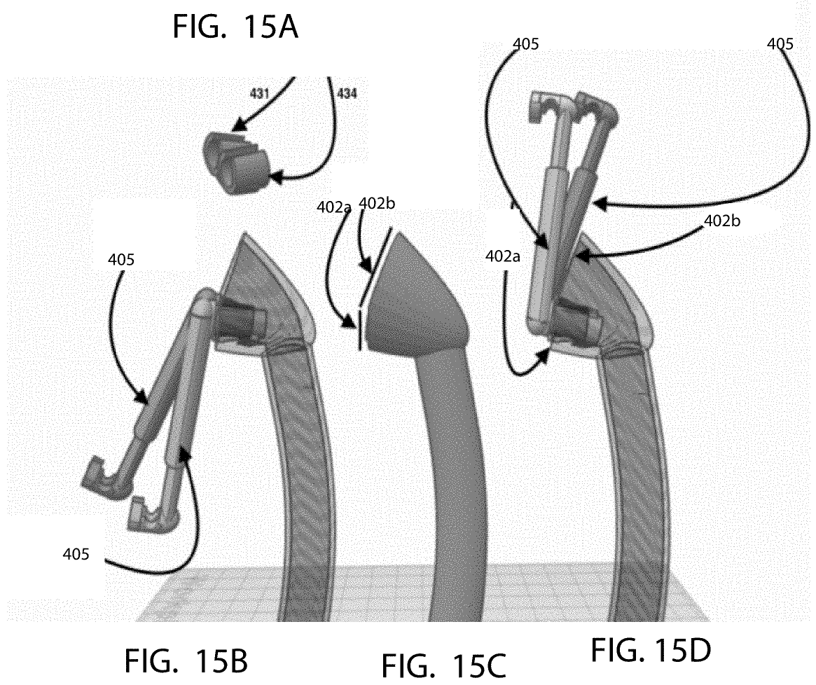

FIG. 15A is a view of the outer frames 431 and 434 formed as a single piece and then inserted into hood 402 (see FIG. 15B). When these clips 405 are inserted into the different outer frames they can be angled at different angles inside of a patient's mouth. Hood 402 includes two separate angled faces 402a 402b as well (See FIG. 15C). Alternatively, as shown in FIG. 15D, the clips 405 can be rotated up before the device is inserted into a patient's mouth so that during insertion of the clip into the hood the clip 405 is rotated up the flange 423 slides through slot 427 before it is rotated down into a locked position.

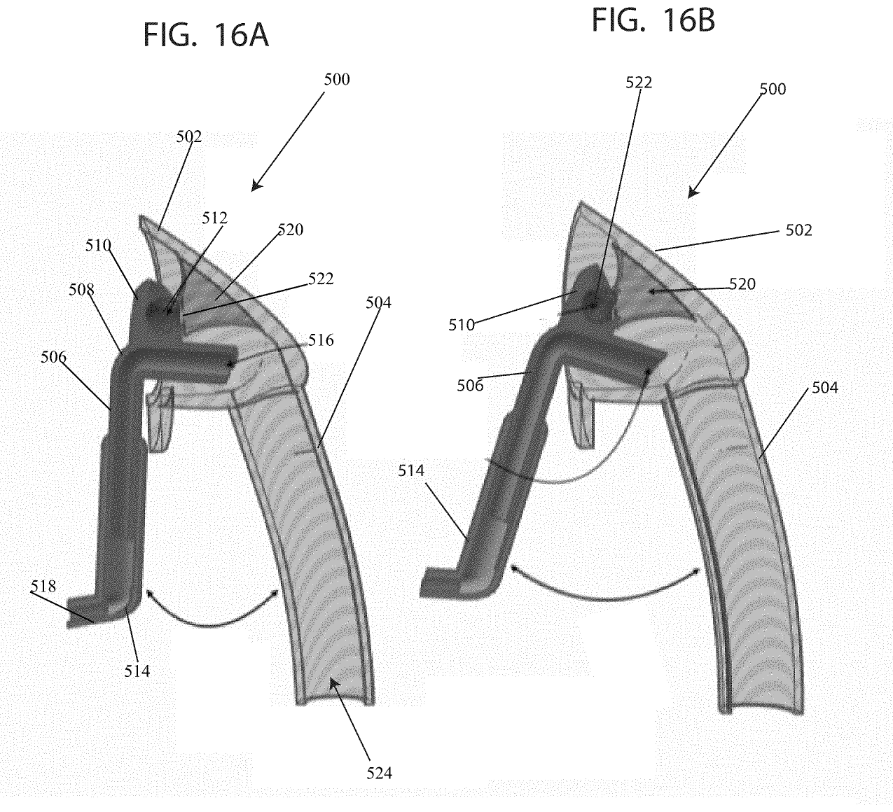

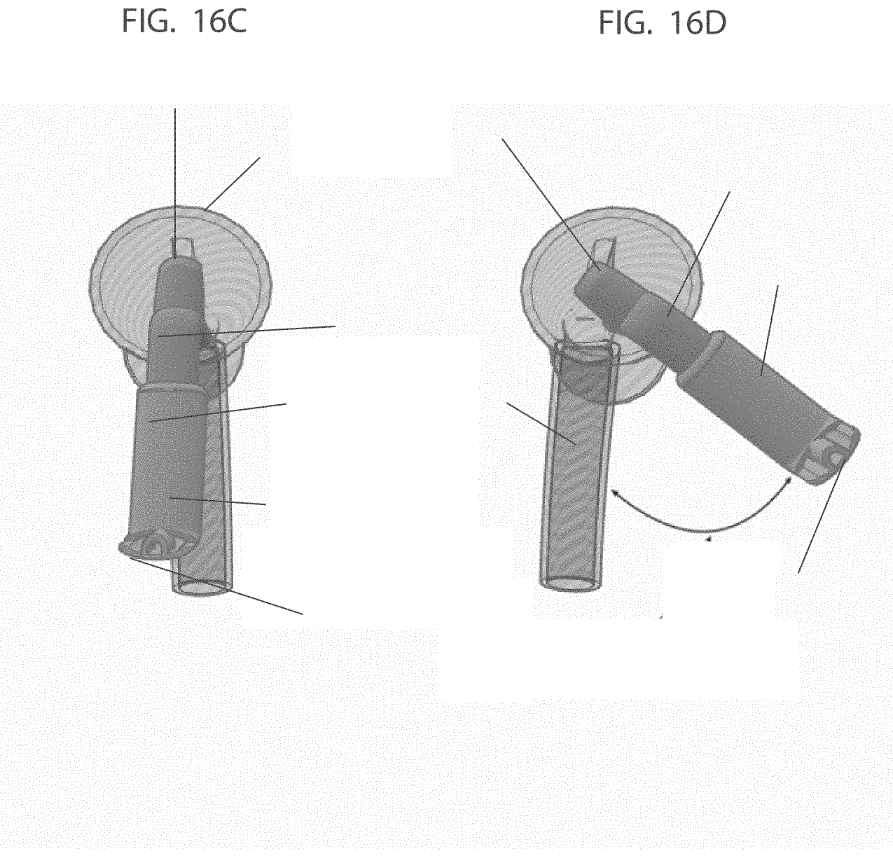

FIG. 16A is a side cut away view of another embodiment of the invention which includes an extra oral dental device 500 which includes a hood 502, having a shaft 504. Coupled to the hood 502 is a connector arm 520 having a connector head 522. There is an arm 506 which is coupled to the connector head 522 via a connector section 510. Connector section 510 has a recess 512 thereby forming a ball and socket joint between recess 512 and connector head 522. Bottom arm 514 extends down in an L-shaped manner to an open end 518. Open end 518 is configured to draw fluid from a person's mouth through the bottom arm 514 up through the upper arm 506 out of an opening 516 and down through shaft 504 and to an exhaust end 524.

The ball and socket joint is configured as a universal joint which is configured to allow the arms such as arms 506 and 514 to rotate and move in multiple different direction as shown in FIG. 16B. The joint formed between the union of the connector head 522 and the recess 512.

FIGS. 16C and 16D show the arms 506 and 514 which are coupled to the head (not shown). This connection shows that the arms can rotate around a radius. This rotation around a radius allows for the arms 506 and 514 to rotate away from a person's mouth or rotate back into the person's mouth. The rotation allows for the arms 506 and 514 to rotate away from shaft. 504.

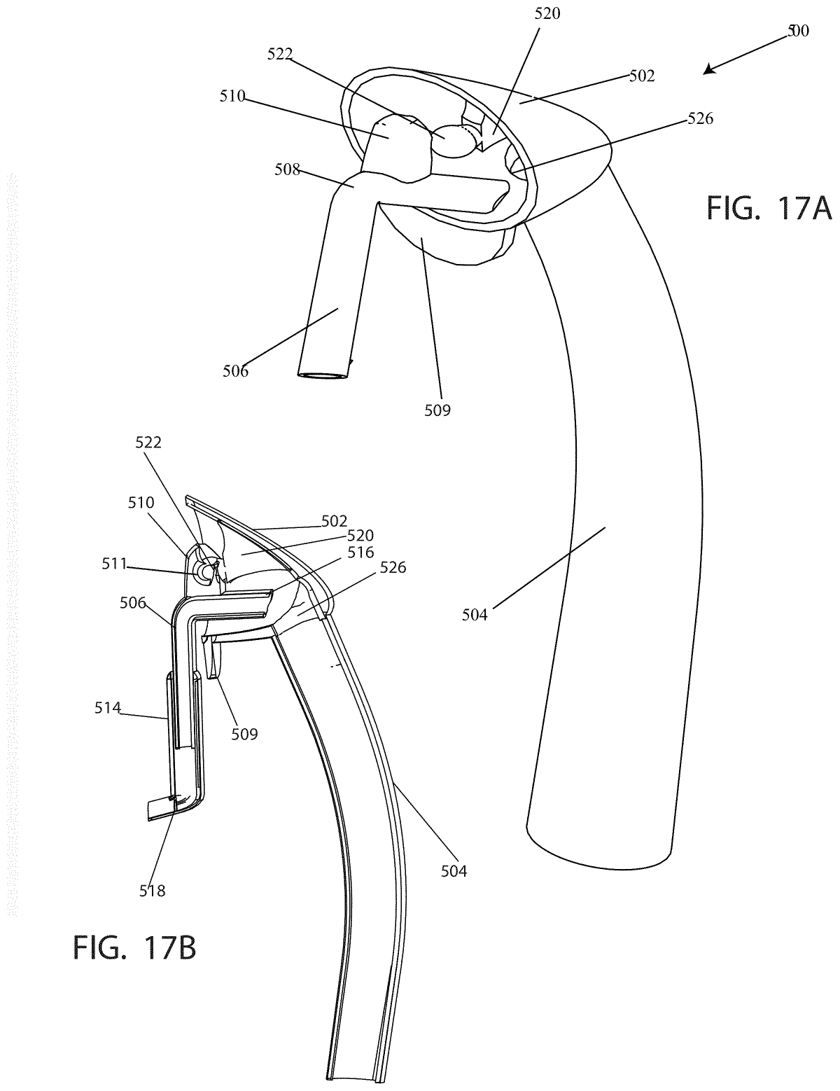

FIG. 17A shows a perspective view of some of the components and a detached manner. For example there is shown head 522 which is configured to fit inside of connector section 510. Connector section 510 is coupled to upper arm 506 which has an end spout 516. Spout 516 is configured to feed into opening 526 in hood 502 which feeds into shaft 504. There is also shown a flange 509 which extends radially out from hood 502.

FIG. 17B shows a side cut-away view of the assembled device which has the hood 502, the shaft 504, upper arm 506, lower arm 514, connector section 510 coupled to head 522, via spherical recess 511 formed to receive the head 522 in a ball and socket joint. Clip 509 is also shown as well as arms 520 holding head 511 in place. Spout 516 is shown feeding into opening 526 of hood 502. Lower arm 514 feeds down to opening 518.

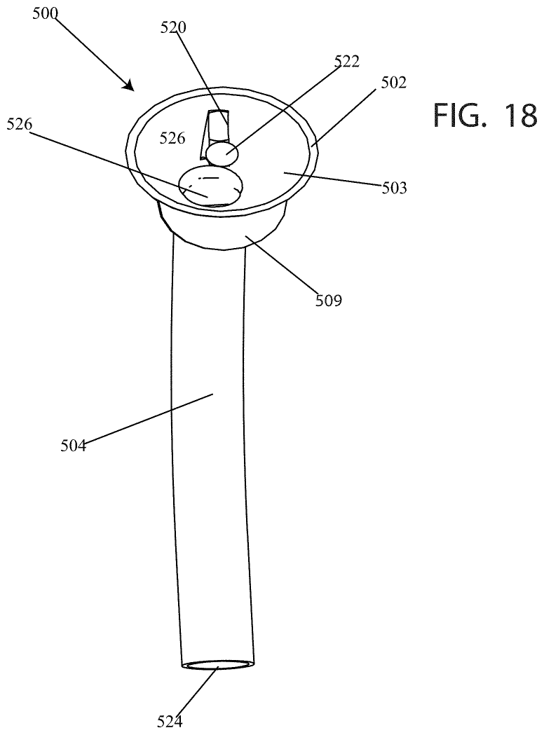

FIG. 18 shows the main hood assembly 501 which includes hood 502, arms 520 as well as head 522. Arms 520 and 522 is fabricated of a rigid material. The movement of arms 506 and 514 is allowed with the union of 522 inserted into 510 (via 511) This “ball and socket” union allows for both rational movement and change in angle of upper arm 506 and lower arm 514 in relation to shaft 504 FIGS. 15A and 15B. The arms can be made from any material suitable for use as a disposable or reusable/sterilizable device.

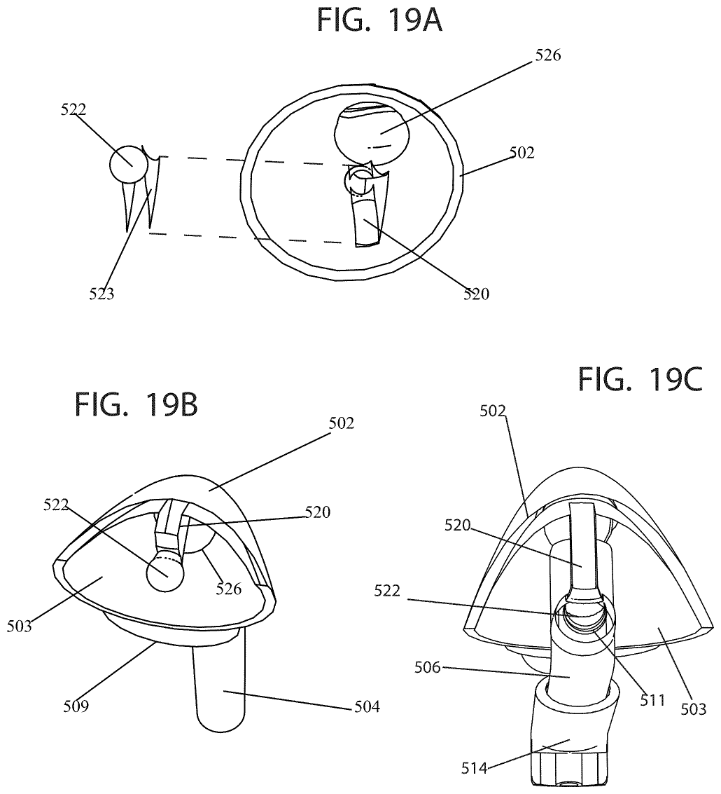

FIG. 19A shows the disassembly of the hood section 502. With this view, there are shown arms 523 and head 522 coupled to arms 523. These arms 523 fit inside of connector arm 520 which houses these separate arms 523 inside of hood 502. Opening 526 is also shown in hood 502. FIG. 19B shows a cut away view of this hood 502 which shows opening 526 adjacent connector head 522. Inner bowl 503 is shown in hood 502 as well as flange 509. Connector arm 520 is shown assembled with head 522. In addition, opening 526 is also shown leading down to shaft 504. FIG. 19C shows a cut away view of the device with hood 502 cut away. There is shown arms 520 leading to head 522 which extends into spherical recess 511 forming the ball and socket joint. An inner surface 503 of the hood is shown as well as upper arm 506 and lower arm 514.

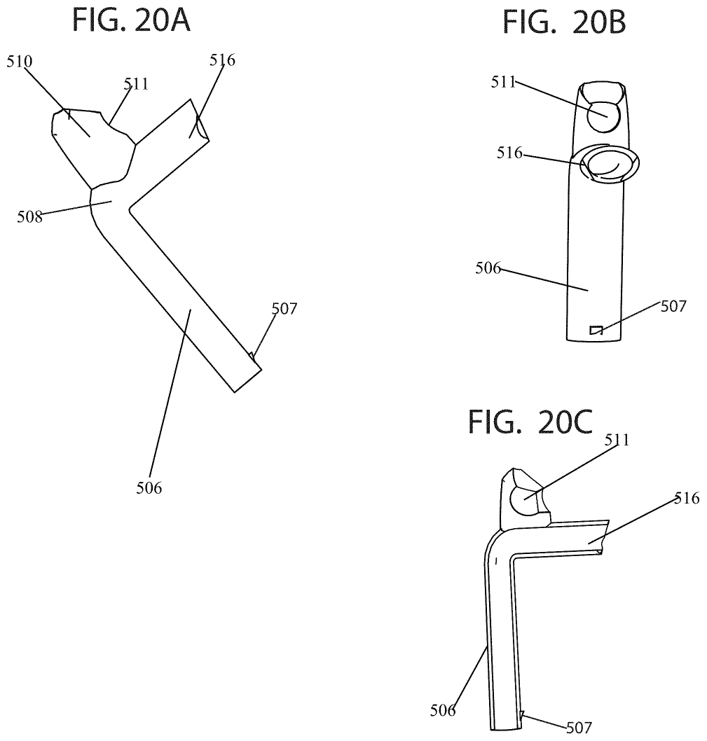

FIG. 20A shows a side view upper arm 506. Upper arm 506 has a spout 516 which feeds into opening 526. A connector head 510 is shown having opening 511 (See also FIGS. 20B and 20C). Opening 511 is configured to receive connector head 522 forming a ball in a ball and socket connection wherein opening 511 is the socket in the connection. Upper arm 506 has a bend region 508 forming an L-shaped arm 506. As shown in FIGS. 20B and 20C, opening 511 is a substantially spherical recess thereby forming a receptacle for the head 522. Arm 506 also includes a protrusion 507, which is configured to fit inside of a slot on lower arm 514. This protrusion 507 also acts as a stop, so that once the two arms 506 and 514 are fit together, they can slide but stay together.

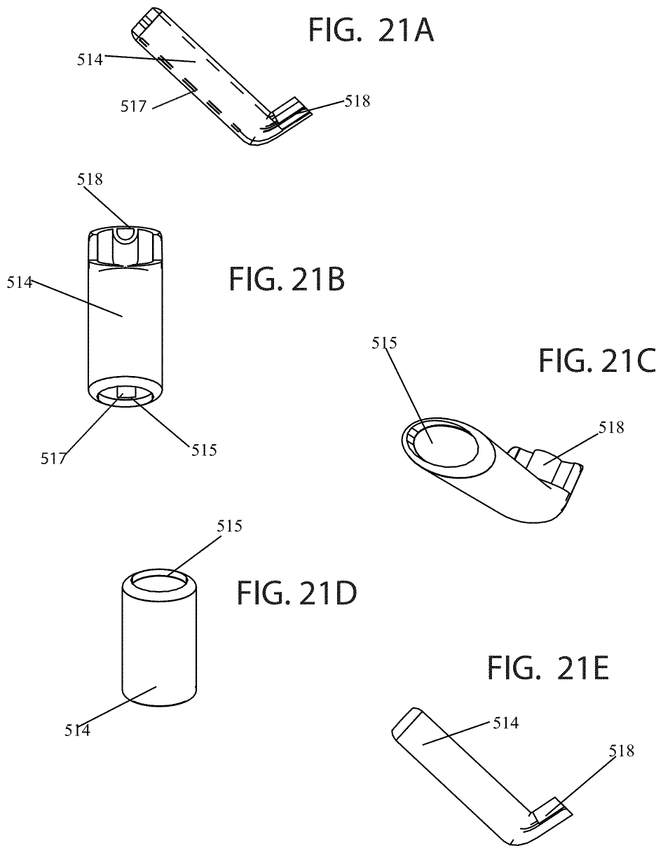

FIGS. 21A-21E show different views of the lower arm 514 which is a substantially L-shaped arm which has a receptacle end 515 configured to fit around a bottom end of upper arm 506. Lower arm 514 is substantially L-shaped and has an open end 518 which is formed as a smaller tube for receiving fluid from a person's mouth. Disposed inside of arm 514 is a slot 517 configured to receive a protrusion 507 on arm 506. Protrusion 507 on arm 506 is configured to limit the the movement of lower arm 514 along upper arm 506 to an axial movement of limited length as enforced by protrusion 507 sliding in slot 517.

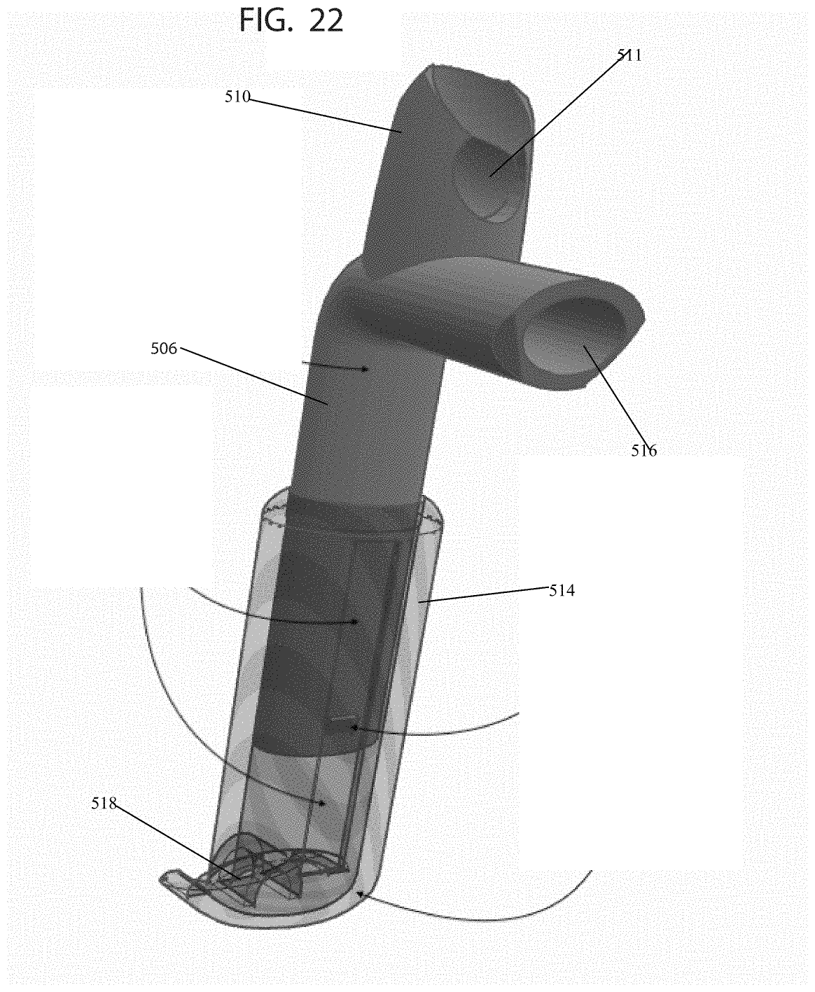

FIG. 22 is a view of the upper arm 506 and the lower arm 514 together. As shown upper arm has an open spout 516 while lower arm 518 has an open end formed as a tube. The upper part of lower arm 514 is has receptacle end 515 (See FIG. 21C) which is configured to receive upper arm 506. Opening 511 is shown positioned above spout 516 and configured to receive head 522.

Thus there is formed a set of arms that are coupled to the hood 502 which are capable of moving in a substantially omnidirectional manner so as to ensure the comfort of the user when the device is placed in or near the user's mouth.

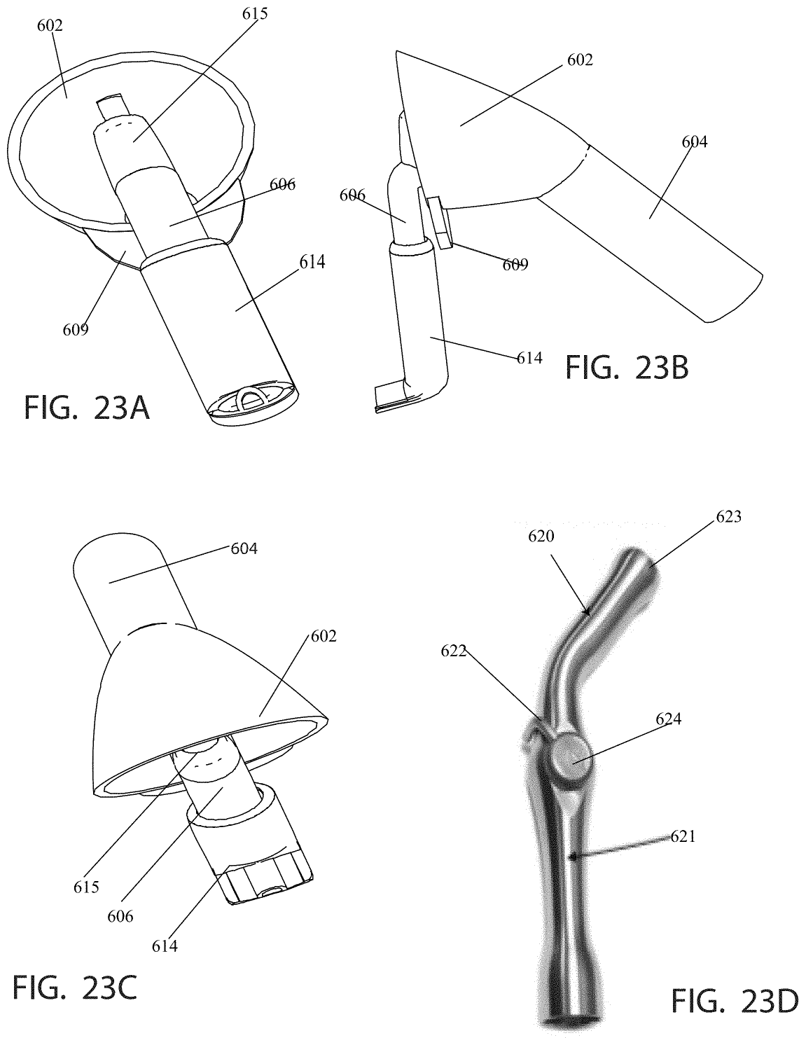

FIG. 23A is a front view of the shortened version of the device. In this view there is a hood 602, an upper arm 606, a lower arm 614 and a shaft 604. There is also shown a clip 609 coupled to the hood 602. Upper arm 606 is coupled to hood via a ball and socket joint wherein the socket 615 is shown coupled to upper arm 606.

FIG. 23B is a side view of the shortened version of the device, which shows a shortened shaft 604 coupled to hood 602. As shown clip 609 is coupled to hood 604. Arms 606 and 614 are coupled to hood 602; wherein arm 606 is an upper arm while arm 614 is a lower arm. Shaft 604 extends down to approximately a same level as arms 606 and 614. FIG. 23C also shows this feature. FIG. 23D show a HVE valve 620 which is configured to be coupled to a bottom end of shaft 604 and can be used to control air flow through hood 602. A lever 622 is coupled to a rotatable joint 624 which allows for the selective opening and closing of the valve. This HVE valve is configured so that it is angled to form a suitable connector to an angled shaft 602 on this shortened device. Thus, the valve can be closed via lever 622 to stop air flow or negative pressure formed in hood 620, or the valve can be opened when lever 622 is moved into an open position to accept air flow through the valve and create a negative pressure in shaft 604, hood 602, chambers inside of upper arm 606 and lower arm 614 as well as in the valve 620 itself. Valve 620 includes an upper arm 623, a lower arm 621, a lever 622 which rotates around a joint 624, to selectively open and close the valve.

The shaft 604, hood 602, and arms 606 and 614 all function as with the embodiment shown in FIGS. 16-23 only shaft 604 is configured as shorter than the embodiment of FIGS. 16-23.

Although the invention has been described in detail for the purpose of illustration, it is understood that such description and detail is solely for that purpose, and variations can be made therein by those skilled in the art without departing from the spirit and scope of the invention which is defined by the following claims.

What is claimed is:

1. A dental device configured to be coupled to a vacuum comprising:
a) at least one channel coupled to the vacuum and in fluid communication with the vacuum;
b) at least one hood coupled to said at least one channel, and covering said at least one channel wherein said hood is in fluid communication with said at least one channel;
c) at least one universal joint coupled to said at least one hood;
d) at least one clip coupled to said at least one universal joint, said at least one clip extending substantially parallel to said at least one channel, wherein the vacuum is configured to create a negative pressure inside of said at least one hood, and wherein said at least one clip is configured to couple to a user's mouth, wherein said hood is positioned adjacent to a user's mouth.

2. The dental device as in claim 1, further comprising at least one additional channel in communication with said at least one channel.

3. The dental device as in claim 2, wherein said at least one additional channel is smaller in diameter than said at least one channel.

4. The dental device as in claim 2, wherein said at least one additional channel extends at least partially inside of said at least one clip.

5. The dental device as in claim 1, wherein said at least one clip comprises at least two parts comprising a first part and a second part, wherein said second part is disposed at least partially inside of said first part of said clip and wherein said second part is slidable inside of said first part forming a telescoping clip that is adjustable in length.

6. The dental device as in claim 1, wherein said at least one hood is semi spherical.

7. The dental device as in claim 1, wherein said at least one universal joint comprises at least one ball coupled to said at least one hood, and at least one socket coupled to said at least one clip.

8. The dental device as in claim 2, wherein said additional channel is disposed in said clip.

9. The dental device as in claim 8, wherein said clip further comprises at least one hole for receiving fluid therein.

10. The dental device as in claim 1, wherein said at least one clip is rotatable.

11. The dental device as in claim 1, wherein said at least one clip is configured to extend into a user's mouth.

12. The dental device as in claim 1, wherein said at least one clip is a telescoping clip having at least two shafts, comprising at least one inner shaft and at least one outer shaft, wherein said at least one inner shaft is slidable inside of said at least one outer shaft.

13. The dental device as in claim 12, wherein said at least one inner shaft and said at least one outer shaft are each hollow cylinders.

14. The dental device as in claim 13, wherein said at least one clip has a plurality of holes disposed in an end region of said at least one clip.

15. The dental device as in claim 14, wherein said holes of said at least one clip comprises a plurality of holes with at least one hole on a first face of said clip and at least one hole on a second face of said at least one clip.

16. The dental device as in claim 1, wherein said clip is coupled to said hood via at least one intermediate shaft extending substantially perpendicular to said clip.

17. The dental device as in claim 1, wherein said channel comprises at least two channels comprising at least a first channel and a second channel coupled together with at least one coupling.

18. The dental device as in claim 17, wherein said at least one coupling is a rotatable coupling wherein said first channel and said second channel are rotatable vs each other.

19. The dental device as in claim 18, wherein said first channel and said second channel intersect each other at an angle offset from a straight line.

20. The dental device as in claim 19, wherein said at least one coupling comprises at least one protrusion coupled to said first channel and at least one indent coupled to said second channel wherein said at least one protrusion is slidable inside of said indent on said second channel.
